(19) United States
(12) Patent Application Publication
(10) Pub. No.: US 2023/0287544 A1
(43) Pub. Date: Sep. 14, 2023

(54) NON-GRAIN-ORIENTED FLAT METAL PRODUCT, METHOD FOR PRODUCTION THEREOF AND USE

(71) Applicant: ThyssenKrupp Steel Europe AG, Duisburg (DE)

(72) Inventors: Olaf FISCHER, Bochum (DE); Karl TELGER, Coesfeld (DE); Anton VIDOVIC, Essen (DE); Nina Maria WINKLER, Essen (DE); Julia DAAMEN, Duisburg (DE); Aleksander Matos COSTA, Essen (DE)

(21) Appl. No.: 18/019,611

(22) PCT Filed: Jun. 4, 2021
(86) PCT No.: PCT/EP2021/064998

§ 371 Date: Feb. 3, 2023

(30) Foreign Application Priority Data
Sep. 1, 2020 (EP) 20193920.4

(51) Int. Cl. C22C 38/04; C22C 38/28; C22C 38/06; C21D 8/02; C21D 9/52

(52) U.S. Cl. CPC C22C 38/04; C22C 38/28; C22C 38/06; C21D 8/0273; C21D 8/0278; C21D 8/0226; C21D 8/0263; C21D 8/0236; C21D 9/52; C22C 2202/00

(57) ABSTRACT

The invention relates to a non-grain-oriented flat metal product, which inter alia has comparatively high weight proportions of Mn and Cr. The invention also relates to a method of production and to a use.

### BACKGROUND

The subject disclosure relates to a non-grain-oriented flat metal product, to a method for producing a flat product, and also to a use.

In the context of the developments described, the term flat metal product comprises in particular rolled products, such as steel strips or steel sheets, cuts or blanks produced by means of pouring. In particular, the subject disclosure relates to flat products which are formed as an electrical strip made of steel and flat products which are formed as an electric sheet made of steel.

Non-grain-oriented flat products, in particular non-grain-oriented electrical steel strip or sheet, are required in many electrotechnical applications.

Non-grain-oriented electrical steel strip or sheet, often also referred to as “NO electric steel strip” or “NO electric steel sheet” (“NGO”=Non Grain Oriented), serves, for example, as base material for the production of components of a rotating electric machine. In such an application, the non-grain-oriented flat metal product is used to control and amplify the course of electromagnetic fields. Typical fields of application of such strips and sheets are rotors and stators in electric motors and electric generators.

In the case of many electric motors, operation at high rotational speeds per unit of time is desired, for example in the case of motors which are developed for applications in the context of so-called electromobility and are thus becoming increasingly important. Operating an electric motor at high rotational speeds is accompanied by high frequencies of the required electromagnetic alternating field, which is ultimately the basis for driving the motor. Therefore, materials are increasingly required which are designed for application in electromagnetic alternating fields with comparatively high frequencies.

When developing electric motors for operation with high-frequency alternating fields, the material developer is faced with the challenge of making a contribution to increasing the efficiency of the electric motor. Against this background, non-grain-oriented flat metal products, in particular non-grain-oriented electrical steel strip and non-grain-oriented electrical steel sheet, are required, which combine comparatively low remagnetization losses at comparatively high frequencies with a comparatively high magnetic polarization and induction as well as comparatively high permeability.

Good combinations of these properties are brought about in proven electrical steel strips and electric steel sheets by a high weight proportion of silicon and/or aluminum in the starting alloy of the electric steel strip or respectively of the electrical steel sheet. However, high proportions of these elements are generally accompanied by the disadvantageous effect that corresponding previously known NO electrical steel strips or NO electric steel sheets with the properties mentioned as a result of their high silicon and/or aluminum content have a comparatively high degree of brittleness, with the associated disadvantages in terms of processability, for example in terms of cold rolling capability. For example, during cold rolling of corresponding NO electric steel strip, strip tears may increasingly occur.

### BRIEF DESCRIPTION

Against the background of the above explanations, one object of the subject disclosure is to provide alternatives for known flat steel products which, in terms of their magnetic properties, meet the specified requirements to the same or a higher degree. The flat products to be provided should be usable even at very low final thicknesses of, for example, less than 0.35 mm.

According to one aspect, a non-grain-oriented flat metal product is provided, which consists of a steel having the alloy components mentioned below, the elements indicated in weight percent, briefly: Wt.%:

### C: 0.0020 to 0.005;

### Si: 2.6 to 2.9;

### Al: 0.5 to 0.8;

### Mn: 1.1 to 1.3;

Cr: 0.7 to 1.6, preferably 0.9 to 1.6, particularly preferably 1.0 to 1.6;

### N: 0.0001 to 0.0060;

### S: 0.0001 to 0.0035;

### Ti: 0.001 to 0.010;

### P: 0.004 to 0.060;

optional components: 0.001 up to 0.15;
remainder Fe and unavoidable impurities.

It is understood that the specification of the remainder relates to the fact that the weight proportions of all alloying components including the remainder add up to 100 wt. %.

In particular, Ni, Cu, Sn, Co, Zr, Nb, V and Mo may be present as optional components, as long as the sum of the weight proportions of these elements does not exceed the limit given above.

Due to the process, Mg and Ca may be contained in a proportion of between 0.0005 and 0.005 wt. %, and in the context of this description are contained in the above-mentioned unavoidable impurities.

A crucial measure for providing a flat product with a property combination of advantageous magnetic properties and advantageous mechanical properties was achieved by considerably increasing the Mn content and the Cr content of the flat product with the alloy specification according to one aspect of subject disclosure compared to known compositions of electric steel strips or sheets.

Surprisingly, the insofar increased Mn content and the insofar increased Cr content not only produce a property profile of the magnetic properties within the scope of the desired values compared to materials with a high Si and/or Al content, but low Mn and/or Cr content, but also produce surprising results, which indicate advantageous behavior under mechanical stress, for example during cold rolling. Both are explained in detail and substantiated below in the context of the description of produced examples.

With regard to the magnetic properties, surprisingly it has been shown that the materials according to the subject disclosure combine a comparatively high magnetic polarization with comparatively low remagnetization losses.

Preferably, the non-grain-oriented flat product is non-grain-oriented electrical steel strip or non-grain-oriented electric steel sheet, each made of a steel having an alloy composition according to one aspect of the subject disclosure.

Preferred flat products according to the subject disclosure have polarizations and remagnetization losses for which the following relations apply alternatively or cumulatively:

Abs[P_{1.0;1000}×d/(J_{200;1000}×([Mn]+[Cr])\hat{ }2)]<9, and/or

P_{1.0;400}<16 W/kg, and/or

P_{1.0;1000}<70 W/kg.

The formula symbols in the upper formula are selected as follows:
“Abs[ ]”: absolute value of the values within the square brackets;
P_{1.0;1000}: remagnetization losses in W/kg in an electromagnetic alternating field with 1000 Hz remagnetization frequency and 1.0 T magnetic flux density in the material;
P_{1.0;400}: remagnetization losses in W/kg in an electromagnetic alternating field with 400 Hz remagnetization frequency and 1.0 T magnetic flux density in the material;
J_{200;1000}: magnetic polarization at a magnetic field strength of 200 A/m in an electromagnetic alternating field with 1000 Hz;
d: thickness of the material in mm.

All numerical values of the above values are to be used within the square brackets of the formula as dimensionless numerical values, that means: without the units. It is an empirically found formula which summarizes the results obtained and is valid for the preferred samples according to the subject disclosure when the dimensionless numerical values are used which are associated with the above-mentioned formula symbols having the units indicated above.

The relation P_{1.0;400}<16 W/kg indicates that remagnetization losses in W/kg in an electromagnetic alternating field with 400 Hz remagnetization frequency and 1.0 T magnetic flux density in the material are less than 16 W/kg.

The relation P_{1.0;1000}<16 W/kg indicates that remagnetization losses in W/kg in an electromagnetic alternating field with 1000 Hz remagnetization frequency and 1.0 T magnetic flux density in the material are less than 70 W/kg.

Alternatively, or additionally, the following preferably applies:

J_{200;1000}>1.0, that is to say the magnetic polarization at a magnetic field strength of 200 A/m in an electromagnetic alternating field of 1000 Hz is greater than 1.0 T.

Methods for determining polarization and field strength are known to the person skilled in the art, for example by means of an Epstein frame for determining the polarization, in particular according to DIN EN 60404-2:2009-01: Magnetic materials—Part 2: Method for determining the magnetic properties of electrical steel strip and sheet using an Epstein frame.

Preferred flat products may alternatively or additionally be characterized in that at any temperature between 18° C. and 28° C. inclusive, thus including 18 and 28° C. as well, preferably at any temperature between 20° C. and 24° C. inclusive, the following relation is maintained:

2.2≤([Mn]+[Cr])²×[ρ_{spec}]≤5.5

where:
[Mn]: dimensionless value of the Mn content in wt. %,
[Cr]: dimensionless value of the Cr content in wt. %,
[ρ_{spec}]: dimensionless value of the specific electrical resistance in Ωmm²/m, in particular of finally-annealed cold strip.

It has been found that flat products in which the above-mentioned relationship between specific electrical resistance and Mn- and Cr content is fulfilled combine the desired properties to a particularly desired extent. The relation links the weight proportion of Mn in the steel alloy to the weight proportion of Cr in the steel alloy. As a result, it is achieved for a given specific resistance that, on the one hand, a minimum content is also present in the sum of both of Mn or Cr, with which the specific resistance and the associated electromagnetic properties may be brought about and, on the other hand, a maximum content of Mn or Cr is not exceeded even in the sum of the two, with the associated disadvantages in the electromagnetic properties.

A particularly preferred flat product may alternatively or additionally be characterized by the surprisingly observed property of the flat product that an annealing of the production process results in an increased content of Mn and Cr in the surface layers. In other words: Mn and Cr accumulate in the edge layers of the flat product compared to the interior of the flat product.

This means, for example, that there is a depth below the surface up to which the flat product has a higher Mn content and a higher Cr content in an above-defined dimension than in the interior of the flat product, wherein, of course, this depth exists on both sides, that is to say on the upper side and on the lower side of the flat product.

Preferably, the flat product has a content of Mn and Cr in an edge layer, that is to say: a boundary region to the surface, which integrated over the volume of this boundary region in relation to a content of Al and Si is a value of 0.2 or higher.

In a particularly preferred special case, the flat product has a content of Mn and Cr in the uppermost 0.95 micrometers below its surface, integrated over the volume of this boundary region, which is a value of 0.2 or higher in relation to a content of Al and Si.

In other words, it is preferred that the surface layer of 0 to 0.95 μm, that is to say up to a depth of 0.95 micrometers below the surface, after the final annealing, that the ratio of the sum of the mass density of the volume integral of Mn and Cr to the sum of the mass density of the volume integral of Si and Al is greater than or equal to 0.2.

Mathematically expressed by:

∫₀^{0.95}([Mn]+[Cr])/∫₀^{0.95}([Al]+[Si])≥0.2

where:
[Mn]: dimensionless value of the Mn content in wt. %,
[Cr]: dimensionless value of the Cr content in wt. %,
[Al]: dimensionless value of the Al content in wt. %,
[Si]: dimensionless value of the Si content in wt. %,
the boundaries of the integral indicate the depth in micrometers below the surface and the integral symbol symbolizes that up to a depth of 0.95 μm and over the entire surface of the flat product preferred according to one aspect of the subject disclosure, the ratio of the sum of Mn content and Cr content to the sum of Al content and Si content is greater than 0.2.

Surprisingly, it has been shown in depth-resolved element analyses that with the element composition present according to the subject disclosure the prerequisite for the stated enrichment of Mn and Cr in regions close to the surface of the flat product is provided. This special feature of the element enrichment of Mn and Cr in the regions near the surface was experimentally determined on finally-annealed samples by means of glow-discharge optical emission spectroscopy (GDOES) according to test specification ISO 11505:2012-12.

Due to the particular and novel distribution of the elements in the surface layer up to a depth of 0.95 μm of the flat product according to one aspect of the subject disclosure having a higher Mn and Cr content compared to conventional high silicon electrical steel strip flat products, it may be prevented to a certain extent that the embrittling ordering phases (D03 structures) known to the person skilled in the art are formed by an enrichment of high Si and Al contents in the surface, presumably brought about by an Mn- and Cr-related “disturbance” of the order in the atomic lattice. As a result of the fact that the known Si and Al-induced brittle phases are inevitably reduced in extent due to the described proportional excess weight in the sense of an occurred enrichment of Mn and Cr relative to the Si content and Al content, the disadvantageous effects of these brittle phases on the formability known to the person skilled in the art are consequently omitted, which is why the flat products according to one aspect of the subject disclosure and their developments exhibit a better processability during cold rolling, punching and coating, and generally during forming.

Particularly preferably, a flat product according to one aspect of the subject disclosure may alternatively or additionally be characterized in that the specific electrical resistance at a temperature of 28° C. has a value between 0.60 Ωmm²/m and 0.70 Ωmm²/m, more preferably between 0.60 Ωmm²/m and 0.65 Ωmm²/m. A specific electrical resistance with this specification correlates with the good magnetic properties obtained.

Particularly preferably, the flat product is present with a maximum thickness of less than 0.35 mm, wherein a thickness between 0.19 mm and 0.31 mm is particularly preferred. In one embodiment, the flat product is a sheet metal or a strip, the thickness of which meets the mentioned criterion at every point. The flat product is preferably present in the mentioned low thicknesses, since at these low thicknesses the remagnetization losses are lower than at higher thicknesses. As a result of the expected excellent cold rolling ability, the improved processability of the flat product according to one aspect of the subject disclosure thus unfolds its particular advantages.

One of the methods explained below may be used to produce materials that have the advantages based on the alloy specification described at the beginning. For example, the method according to the present disclosure explained below produces a flat product which has a particularly advantageous combination of properties. The following steps are performed:
A) melting a melt containing an element composition according to the aforementioned alloy specification;
B) casting the melt to form a rollable preliminary product, in particular a preliminary strip, a slab or a thin slab;
C) hot rolling of the preliminary product with a final rolling temperature between 820° C. and 890° C.;
D) pickling;
E) optionally hot strip annealing;
F) cold rolling;
G) final annealing.

Within the scope of the present disclosure, final annealing is understood to mean the annealing of the flat product according to the subject disclosure at the end of the production method, that is to say as the last method step before the insulating lacquer coating.

Particularly advantageous properties are obtained when the preliminary product is heated to a preheating temperature of not more than 1200° C. at the beginning of the hot rolling.

Step D) takes place after step C)

It is particularly preferred that the hot strip is coiled following step C) or, if it is carried out, following step D), before, if carried out, step E) and/or before step F) with a coiling temperature between 500° C. and 750° C.

Preferably, the hot strip annealing of step E) is carried out at a temperature between 700° C. and 790° C. It is preferred that the hot strip annealing is carried out for not less than 12 hours and not more than 36 hours.

The cold rolling of step F) results in particularly advantageous properties of the flat product obtained in the case of a total cold rolling degree between 75% and 90%. It is particularly preferred if the flat product is rolled to a thickness of between 0.19 mm and 0.31 mm. More preferably, no more than four passes are carried out.

For final annealing, properties have proven to be advantageous when it is carried out at a preferred temperature of between 930° C. and 1070° C., wherein particularly preferably the duration of the final annealing is a maximum of 300 seconds. The minimum duration of the final annealing is preferably 50 seconds.

Final annealing is preferably carried out in a continuously operated furnace through which the flat product is to pass, for example in a horizontal continuous furnace.

It is particularly preferred if the described final annealing is carried out in one stage, but not in two stages.

Particularly preferably, steps A) to G) are carried in their alphabetically specified order.

Another aspect of the present application is a flat product which may be obtained with any of the aforementioned methods or their developments.

Another aspect of the present application is a use of a cutout which is punched out of one of the aforementioned flat products, as a lamella of a rotating electrical machine.

### DETAILED DESCRIPTION

### Examples

Aspects of the subject disclosure are explained in more detail below with reference to exemplary embodiments.

Three (3) electrical steel strips according to the subject disclosure were produced, hereinafter referred to as variant 1, variant 2 and variant 3. The compositions of variants 1, 2 and 3 are listed in Table 1. Further variants, referred to as variant Ref. 1, variant Ref. 2 and variant Ref. 3, serve as comparative samples not according to the subject disclosure, the alloy compositions of which are likewise listed in Table 1.

From the listed alloys, low sulfur and nitrogen contents were adjusted via a ladle furnace and slabs were produced via continuous casting and thin slab casting, respectively. A strip was then produced from each of these by hot rolling, pickling, hot strip annealing, cold rolling and final annealing. In the examples, the material was heated to a maximum of 1200° C. prior to hot rolling, rolled to a hot strip thickness of 1.3-1.9 mm to a final rolling temperature of 820° C.-890° C. and coiling temperature of 500° C.-750° C.

The hot strips produced are pickled and subsequently annealed at 700-790° C. for 24 hours, wherein this step is not necessarily part of the subject disclosure, i.e., it is optional. The annealed hot strip was formed, at a total cold rolling degree of 75-90%, to a final thickness of 0.19-0.31 mm (+/−8%) with a maximum of 4 passes.

Final annealing is carried out at a maximum temperature between 930-1070° C.

The production parameters of variants 1 to 3 and Ref. 1 to Ref. 3 are listed in Table 1.

TABLE 1

| | Preheating | | | | | | | | |
|---|---|---|---|---|---|---|---|---|---|
| | temperature | | | | Hot strip | Total | | | Final |
| | before hot | Final rolling | | Coiling | annealing | cold | | | annealing |
| | rolling in | temperature | Hot strip | temperature | temperature | rolling | Final | Number | temperature |
| | degrees | in degrees | thickness | in degrees | in degrees | degree | thickness | of | in degrees |
| Sample | Celsius | Celsius | in mm | Celsius | Celsius | in percent | in mm | passes | Celsius |
| Var. 1 | 1120 | 840° C. | 1.6 | 620 | 740 | Different | Different | 4 | Different |
| | | | | | | see Table 4 | see Table 4 | | see Table 4 |
| Var. 2 | 1120 | 840° C. | 1.6 | 620 | 740 | see above | see above | 4 | see above |
| Var. 3 | 1120 | 840° C. | 1.6 | 620 | 740 | see above | see above | 4 | see above |
| Ref. 1 | 1120 | 840° C. | 1.6 | 620 | 740 | see above | see above | 4 | see above |
| Ref. 2 | 1120 | 840° C. | 1.6 | 620 | 740 | see above | see above | 4 | see above |
| Ref. 3 | 1120 | 840° C. | 1.6 | 620 | 740 | see above | see above | 4 | see above |

The specific electrical resistance of the samples was measured after the final annealing. For this purpose, a Wheatstone measuring bridge according to DIN EN 60404-13:2015-01 was used.

TABLE 2

| | | | | | | | | | | Spec. | |
|---|---|---|---|---|---|---|---|---|---|---|---|
| | | | | | | | | | | Electrical | |
| | | | | | | | | | | resistance | 2.2 ≤ [ρ_{spec}] × |
| | C | Si | Mn | Al | Cr | P | Ti | N | S | at 28° C. | ([Mn] + [Cr]) |
| Var. | [wt. %] | [wt. %] | [wt. %] | [wt. %] | [wt. %] | [wt. %] | [wt. %] | [wt. %] | [wt. %] | [Ωmm²/m] | \hat{ }2 ≤ 5.5 |
| 1 | 0.0038 | 2.72 | 1.20 | 0.77 | 1.01 | 0.02 | 0.0050 | 0.0026 | 0.0030 | 0.626 | yes |
| 2 | 0.0041 | 2.74 | 1.20 | 0.77 | 1.31 | 0.02 | 0.0050 | 0.0025 | 0.0030 | 0.642 | yes |
| 3 | 0.0040 | 2.70 | 1.20 | 0.70 | 1.60 | 0.02 | 0.0030 | 0.0030 | 0.0030 | 0.643 | yes |
| Ref. 1 | 0.0034 | 3.29 | 0.16 | 0.93 | 0.07 | 0.03 | 0.0040 | 0.0018 | 0.0020 | 0.625 | no |
| Ref. 2 | 0.0031 | 3.22 | 0.16 | 0.75 | 0.02 | 0.01 | 0.0040 | 0.0010 | 0.0012 | 0.588 | no |
| Ref. 3 | 0.0023 | 2.67 | 0.20 | 0.74 | 0.04 | 0.02 | 0.0042 | 0.0010 | 0.0010 | 0.525 | no |

Table 3 shows properties of the prepared samples 1 to 3 and Ref. 1 to Ref. 3.

The magnetic values P at 1.0 T and 1000 Hz and J at 200 A/m and 1000 Hz were determined using a 60×60 mm² panel according to IEC404-3, wherein a mean value of a longitudinal and a transverse value was formed in each case.

In particular, it is found that in addition to the very good polarization, at 1000 Hz and a magnetic field strength of 200 A/m, a desirable low magnetic remagnetization loss P occurs at 1.0 T and 1000 Hz, which is approximately in the order of magnitude of the results obtained at the reference samples.

TABLE 3

| | P at | J at | | \| P(1.0_1000) × d/ | |
|---|---|---|---|---|---|
| | 1.0 T | 200 A/m | | (J(200_1000) × | |
| | 1000 Hz | 1000 Hz | d | ([Mn] + | |
| Variant | [W/kg] | [T] | [mm] | [Cr]\hat{ }2) \| ≤ 9 | Inventive |
| 1 | 61.83 | 1.11 | 0.25 | 2.85 | yes |
| 2 | 60.86 | 1.08 | 0.25 | 2.33 | yes |
| 3 | 58.04 | 1.08 | 0.25 | 1.78 | yes |
| Ref. 1 | 63.75 | 0.98 | 0.27 | 329.15 | no |
| Ref. 2 | 54.64 | 1.20 | 0.25 | 337.55 | no |
| Ref. 3 | 80.17 | 0.91 | 0.35 | 536.70 | no |

Table 4 shows the following properties of the samples 1.1, 2.1, 2.2, 2.3, 3.1 produced from the analyses 1-3 and the samples Ref. 1.1, 1.2, 2.1, 3.1 to 3.5 from the analyses Ref. 1-3; wherein the digits after the dot refer to the fact that a plurality of samples was prepared randomly from one sample for optical analysis to support the robustness of the tests performed. For example, five samples were prepared from reference materials 3, which are numbered 3.1 to 3.5.

The special feature of the element enrichment of Mn and Cr in the surface layers of the flat product was determined by means of glow discharge spectroscopy according to test specification ISO 11505:2012-12. The measurement is carried out on the upper side (OS) and the lower side (US) of the samples. In addition, measurements were made across the bandwidth at the sample locations edge (R1/R2) and middle (M). From the obtained measurement curves of the mass over the sample depth of 0 to 12 μm, an integral evaluation of the mass density from the surface (0 μm) to a sample depth of 0.95 μm was calculated for Mn, Cr, Al and Si.

TABLE 4

| | | | | | | | | | | | Ratio of (sum | |
|---|---|---|---|---|---|---|---|---|---|---|---|---|
| | | | | | | | | | | | of Mn and Cr | |
| | | | | | | | | | | | contents from | |
| | | | | | | | | | | | surface to | |
| | | | | | | | | | | | a depth of | |
| | | | | | | | | | | | 0.95 μm) | |
| | | | | | | | | | | | to (sum of Al | |
| | | | | | | | | | | | and Si contents | |
| | | | | | | | Mass density per area | | | | from a depth | |
| | | | | Final | | | integrated over the | | | | of 0.95 μm) | |
| | | | Cold | annealing | | | volume from the surface | | | | ∫₀^{0.95}([Mn] + | ∫₀^{0.95}( [Mn] + |
| | | | rolling | temperature | | | to a depth of 0.95 μm | | | | [Cr])/∫₀^{0.95} | [Crl)/∫₀^{0.95} |
| | | Thickness | degree | Temperature | OS/US | R1/M/R2 | Mn | Cr | Al | Si | ([Al] + [Si]) | ([Al] + |
| Variant | Sample | [mm] | [%] | [° C.] | position | position | [kg/m³] | [kg/m³] | [kg/m³] | [kg/m³] | [ ] | [Si]) ≥ 0.2 |
| 1 | 1.1 | 0.25 | 84.4 | 1030 | OS | M | 65 | 59 | 127 | 175 | 0.408 | yes |
| 1 | 1.1 | 0.25 | 84.4 | 1030 | US | M | 70 | 61 | 114 | 174 | 0.453 | yes |
| 1 | 1.1 | 0.25 | 84.4 | 960 | OS | M | 47 | 45 | 89 | 157 | 0.376 | yes |
| 1 | 1.1 | 0.25 | 84.4 | 960 | US | M | 58 | 63 | 86 | 194 | 0.432 | yes |
| 2 | 2.1 | 0.35 | 78.1 | 1000 | OS | R1 | 59 | 56 | 126 | 201 | 0.353 | yes |
| 2 | 2.1 | 0.35 | 78.1 | 1000 | US | R1 | 66 | 53 | 142 | 210 | 0.340 | yes |
| 2 | 2.1 | 0.35 | 78.1 | 1000 | OS | M | 62 | 61 | 127 | 214 | 0.361 | yes |
| 2 | 2.1 | 0.35 | 78.1 | 1000 | US | M | 73 | 57 | 144 | 232 | 0.348 | yes |
| 2 | 2.1 | 0.35 | 78.1 | 1000 | OS | R2 | 56 | 56 | 117 | 191 | 0.363 | yes |
| 2 | 2.1 | 0.35 | 78.1 | 1000 | US | R2 | 65 | 56 | 134 | 206 | 0.355 | yes |
| 2 | 2.2 | 0.27 | 83.1 | 1000 | OS | R1 | 52 | 51 | 124 | 185 | 0.335 | yes |
| 2 | 2.2 | 0.27 | 83.1 | 1000 | US | R1 | 56 | 54 | 133 | 195 | 0.335 | yes |
| 2 | 2.2 | 0.27 | 83.1 | 1000 | OS | M | 54 | 54 | 116 | 193 | 0.349 | yes |
| 2 | 2.2 | 0.27 | 83.1 | 1000 | US | M | 58 | 61 | 111 | 204 | 0.375 | yes |
| 2 | 2.2 | 0.27 | 83.1 | 1000 | OS | R2 | 61 | 59 | 128 | 199 | 0.367 | yes |
| 2 | 2.2 | 0.27 | 83.1 | 1000 | US | R2 | 57 | 59 | 120 | 194 | 0.370 | yes |
| 2 | 2.3 | 0.25 | 84.4 | 1000 | OS | R1 | 54 | 44 | 136 | 199 | 0.292 | yes |
| 2 | 2.3 | 0.25 | 84.4 | 1000 | US | R1 | 63 | 63 | 133 | 195 | 0.381 | yes |
| 2 | 2.3 | 0.25 | 84.4 | 1000 | OS | M | 62 | 62 | 130 | 201 | 0.378 | yes |
| 2 | 2.3 | 0.25 | 84.4 | 1000 | US | M | 65 | 59 | 148 | 213 | 0.342 | yes |
| 2 | 2.3 | 0.25 | 84.4 | 1000 | OS | R2 | 66 | 61 | 139 | 209 | 0.367 | yes |
| 2 | 2.3 | 0.25 | 84.4 | 1000 | US | R2 | 62 | 63 | 126 | 193 | 0.391 | yes |
| 3 | 3.1 | 0.25 | 84.4 | 1000 | OS | R1 | 50 | 50 | 149 | 172 | 0.310 | yes |
| 3 | 3.1 | 0.25 | 84.4 | 1000 | US | R1 | 57 | 58 | 175 | 182 | 0.323 | yes |
| 3 | 3.1 | 0.25 | 84.4 | 1000 | OS | M | 59 | 60 | 162 | 186 | 0.343 | yes |
| 3 | 3.1 | 0.25 | 84.4 | 1000 | US | M | 58 | 57 | 194 | 183 | 0.305 | yes |
| 3 | 3.1 | 0.25 | 84.4 | 1000 | OS | R2 | 60 | 50 | 208 | 170 | 0.291 | yes |
| 3 | 3.1 | 0.25 | 84.4 | 1000 | US | R2 | 65 | 52 | 195 | 177 | 0.313 | yes |
| Refer- | R1.1 | 0.27 | 83.1 | 1030 | OS | M | 10 | 2 | 150 | 238 | 0.030 | no |
| ence 1 | | | | | | | | | | | | |
| Refer- | R1.1 | 0.27 | 83.1 | 1030 | US | M | 10 | 2 | 121 | 243 | 0.032 | no |
| ence 1 | | | | | | | | | | | | |
| Refer- | R1.2 | 0.25 | 84.4 | 1030 | OS | M | 9 | 2 | 129 | 236 | 0.030 | no |
| ence 1 | | | | | | | | | | | | |
| Refer- | R1.2 | 0.25 | 84.4 | 1030 | US | M | 9 | 2 | 118 | 233 | 0.031 | no |
| ence 1 | | | | | | | | | | | | |
| Refer- | R2.1 | 0.25 | 84.4 | 1030 | OS | M | 12 | 2 | 98 | 247 | 0.040 | no |
| ence 2 | | | | | | | | | | | | |
| Refer- | R2.1 | 0.25 | 84.4 | 1030 | US | M | 12 | 2 | 89 | 247 | 0.041 | no |
| ence 2 | | | | | | | | | | | | |
| Refer- | R3.1 | 0.35 | 78.1 | 1000 | OS | M | 5 | 1 | 138 | 132 | 0.021 | no |
| ence 3 | | | | | | | | | | | | |
| Refer- | R3.1 | 0.35 | 78.1 | 1000 | US | M | 4 | 1 | 133 | 117 | 0.020 | no |
| ence 3 | | | | | | | | | | | | |
| Refer- | R3.2 | 0.25 | 84.4 | 1030 | OS | M | 12 | 2 | 79 | 212 | 0.049 | no |
| ence 3 | | | | | | | | | | | | |
| Refer- | R3.2 | 0.25 | 84.4 | 1030 | US | M | 12 | 2 | 82 | 209 | 0.050 | no |
| ence 3 | | | | | | | | | | | | |
| Refer- | R3.3 | 0.25 | 84.4 | 1030 | OS | M | 11 | 2 | 91 | 217 | 0.044 | no |
| ence 3 | | | | | | | | | | | | |
| Refer- | R3.3 | 0.25 | 84.4 | 1030 | US | M | 12 | 3 | 96 | 203 | 0.050 | no |
| ence 3 | | | | | | | | | | | | |
| Refer- | R3.4 | 0.25 | 84.4 | 1030 | OS | M | 13 | 2 | 122 | 201 | 0.047 | no |
| ence 3 | | | | | | | | | | | | |
| Refer- | R3.4 | 0.25 | 84.4 | 1030 | US | M | 10 | 2 | 103 | 223 | 0.038 | no |
| ence 3 | | | | | | | | | | | | |
| Refer- | R3.5 | 0.25 | 84.4 | 1030 | OS | M | 12 | 2 | 98 | 207 | 0.048 | no |
| ence 3 | | | | | | | | | | | | |
| Refer- | R3.5 | 0.25 | 84.4 | 1030 | US | M | 13 | 2 | 103 | 198 | 0.051 | no |
| ence 3 | | | | | | | | | | | | |

1. A non-grain oriented flat metal product consisting of the components mentioned below in weight percent, abbreviated as: Wt.%:
C: 0.0020 to 0.005;
Si: 2.6 to 2.9;
Al: 0.5 to 0.8;
Mn: 1.1 to 1.3;
Cr: 0.7 to 1.6;
N: 0.0001 to 0.0060;
S: 0.0001 to 0.0035;
Ti: 0.001 to 0.010;
P: 0.004 to 0.060;
optional components: 0.001 up to 0.15;
remainder Fe and unavoidable impurities.

2. The flat product according to claim 1, having at 28° C. a specific electrical resistance of
0.60 Ωmm²/m≤ρ_{spec}≤0.70 Ωmm²/m.

3. The flat product according to claim 1, wherein
Abs[P_{1.0;1000}×d/(J_{200;1000}×([Mn]+[Cr])\hat{ }2)]<9, and/or
P_{1.0;400}<16 W/kg, and/or
P_{1.0;1000}<70 W/kg, and/or
J at 200 A/m and 1000 Hz>1.0.

4. The flat product according to claim 1, wherein at a temperature between 18° C. and 28° C. inclusive, the following applies
2.2≤([Mn]+[Cr])²×[ρ_{spec}]≤5.5
where:
[Mn]: dimensionless value of the Mn content in wt. %,
[Cr]: dimensionless value of the Cr content in wt. %,
[ρ_{spec}]: dimensionless value of the specific electrical resistance in Ωmm²/m of finally-annealed cold strip.

5. The flat product according to claim 1, wherein in a boundary region to the surface up to a depth of 0.95 μm the ratio of a content in kg/m\hat{ }3 of the sum of Mn and Cr to a content in kg/m\hat{ }3 of the sum of Al and Si is 0.2 or greater.

6. The flat product according to claim 1, having a thickness d of
d<0.35 mm.

7. A method for producing a flat product, in particular from an alloy according to claim 1, having the following production steps:
A) melting a melt containing an element composition according to claim 1;
B) casting the melt to form a rollable preliminary product, in particular a preliminary strip, a slab or a thin slab;
C) hot rolling of the preliminary product with a final rolling temperature between 820° C. and 890° C.;
D) pickling;
E) optionally hot strip annealing;
F) cold rolling;
G) final annealing.

8. The method according to claim 7, wherein the preliminary product is heated to a preheating temperature of at most 1200° C. at the beginning of the hot rolling.

9. The method according to claim 7, wherein the hot strip is coiled at a coiling temperature of between 500° C. and 750° C. after step C) or after step D).

10. The method according to claim 7, wherein the hot strip annealing of step E) is carried out at a temperature between 700 and 790° C.

11. The method according to claim 7, wherein the cold rolling of step F) is carried out with a total cold rolling degree between 75% and 90%.

12. The method according to claim 7, wherein the final annealing is carried out at a temperature between 930° C. and 1070° C.

13. The flat product obtainable by a method according to claim 7.

14. (canceled)

15. A use of a cutout punched from a flat product according to claim 1 as a lamella of a rotating electrical machine.

16. The flat product according to claim 3, wherein a thickness of the flat product is between 0.19 mm and 0.31 mm.

17. The flat product according to claim 1, wherein at any temperature between 20° C. and 24° C., the following applies
2.2≤([Mn]+[Cr])²×[ρ_{spec}]≤5.5
where:
[Mn]: dimensionless value of the Mn content in wt. %,
[Cr]: dimensionless value of the Cr content in wt. %,
[ρ_{spec}]: dimensionless value of the specific electrical resistance in Ωmm²/m of finally-annealed cold strip.

18. The flat product according to claim 1, having a thickness d of
0.19 mm<d<0.31 mm.

19. The method according to claim 10, wherein the hot strip annealing of step E) is carried out at a temperature between 700 and 790° C. for a period between 12 h and 36 h.

20. The method according to claim 7, wherein the flat product is rolled with a maximum of four passes and to a thickness between 0.19 mm and 0.31 mm.
